(19) United States
(12) Patent Application Publication
(10) Pub. No.: US 2026/0070073 A1
(43) Pub. Date: Mar. 12, 2026

(54) Liquid Nozzle with a Specialized Waterway

(71) Applicant: Kyle Thon, Austin, TX (US)

(72) Inventor: Kyle Thon, Austin, TX (US)

(21) Appl. No.: 18/829,082

(22) Filed: Sep. 9, 2024

(51) Int. Cl. B05B 1/34; A62C 31/02; B05B 1/04

(52) U.S. Cl. CPC B05B 1/3402; B05B 1/044; A62C 31/02

(57) ABSTRACT

This disclosure concerns a liquid nozzle with a specialized waterway which produces a desirable water spray pattern. The nozzle can be applied to a variety of liquid conduits. The nozzle has a specialized waterway geometry wherein the area of the entry aperture, the area of the exit aperture, and the cross-sectional area of the waterway at every point between the entry aperture and the exit aperture are all equal to each other. Because the cross-sectional area of the waterway remains constant, the nozzle minimizes the amount of turbulence experienced by the flowing liquid. The spray pattern produced from the nozzle shows improved distance, penetrating power, and water spray shape.

### BACKGROUND

### Field of the Invention

This disclosure relates to hydraulic nozzles; more particularly, to a hose nozzle having a specialized waterway.

### Description of the Related Art

Nozzles direct and shape the fluid emitted from them. Some products convert the flow of water out of a circular hose to a different shape, such as a blade spray shape. However, current designs introduce turbulence, and in some cases cavitation, into the water stream and subsequent spray pattern. In some products, the transition between the circular nozzle entry and the blade-shaped exit is not a smooth, continuous transition. In some products, the cross-sectional area of the waterway between the nozzle entry and nozzle exit is not constant. This can cause changes in the fluid velocity, thereby producing additional unwanted turbulence. Furthermore, some nozzles are configured with adjustable flow paths and/or exit shapes such that the spray pattern emitted by the nozzle can be changed. Unfortunately, the same components and features which enable the spray pattern adjustability can cause detrimental turbulence in the water stream and emitted spray pattern. These instances of turbulence reduce desirable fluid dynamics of the spray, including but not limited to, the spray distance, the spray shape, and the penetrating power of the emitted water.

### SUMMARY

This disclosure concerns a liquid nozzle with a specialized waterway which produces a desirable water spray pattern. The nozzle may be coupled to a variety of liquid conduit types, including but not limited to fire hoses, such that the water spray pattern produced by the nozzle is useful, in some cases for extinguishing fires.

The nozzle with a specialized waterway, also called the “nozzle” herein, has an entryway and an exit. The nozzle is joined to the hose such that the liquid enters the nozzle through the entryway and ejected out the exit. Water enters the nozzle through an entry aperture, flows through the nozzle waterway, and exits the nozzle through an exit aperture. The entry aperture may have a circular shape and the exit aperture may have a rectangular shape producing a “blade” water spray pattern. The blade spray pattern may be preferred for some firefighting situations because it produces a water spray with improved distance, improved penetrating power, and an improved water spray shape.

One goal of the nozzle is to reduce the turbulence experienced by the flowing liquid. Turbulence within a nozzle causes the water to follow an irregular path, rather than in straight lines that are substantially parallel with each other. There are a variety of causes of turbulence within hydraulic systems including, but not limited to, material surface roughness, obstructions within the flow path, and changes in geometry of the flow path.

To minimize the turbulence produced by the nozzle described herein, the geometric transition of the waterway between the entry aperture and exit aperture is configured to be smooth, gradual, and continuous. In some preferred embodiments, the cross-sectional area of the waterway remains constant along the waterway. This is to say that the area of the nozzle entry aperture, the area of the nozzle exit aperture, and the cross-sectional area of the waterway at any point between the entry aperture and the exit aperture are equal.

### BRIEF DESCRIPTION OF THE DRAWINGS

Other features, combinations, and embodiments will be appreciated by one having the ordinary level of skill in the art of hydraulic nozzles and accessories upon a thorough review of the following details and descriptions, particularly when reviewed in conjunction with the drawings, wherein:

FIG. 1 shows a perspective view of the nozzle in accordance with a first illustrated embodiment;

FIG. 2 shows a perspective view of the nozzle in accordance with a first illustrated embodiment;

FIG. 3 shows a side profile view of the nozzle in accordance with a first illustrated embodiment;

FIG. 4 shows a top plan view of the nozzle in accordance with a first illustrated embodiment; and

FIG. 5 shows a side sectional view of the nozzle in accordance with a first illustrated embodiment.

FIG. 6 shows a side sectional perspective view of the nozzle in accordance with a first illustrated embodiment.

FIG. 7 shows a side sectional perspective view of the nozzle in accordance with a first illustrated embodiment.

FIG. 8 shows a top sectional view of the nozzle in accordance with a first illustrated embodiment.

FIG. 9 shows a top sectional perspective view of the nozzle in accordance with a first illustrated embodiment.

FIG. 10 shows a top sectional perspective view of the nozzle in accordance with a first illustrated embodiment.

FIG. 11 shows a back end view of the nozzle in accordance with a first illustrated embodiment.

FIG. 12 shows a front end view of the nozzle in accordance with a first illustrated embodiment.

FIG. 13 shows a top sectional view of the nozzle in accordance with a second illustrated embodiment.

FIG. 14a shows a variation of the exit aperture shape in accordance with a third illustrated embodiment.

FIG. 14b shows a variation of exit aperture shape in accordance with a fourth illustrated embodiment.

FIG. 14c shows a variation of exit aperture shape in accordance with a fifth illustrated embodiment.

FIG. 14d shows a variation of exit aperture shape in accordance with a sixth illustrated embodiment.

### DETAILED DESCRIPTION

For purposes of explanation and not limitation, details and descriptions of certain preferred embodiments are hereinafter provided such that one having ordinary skill in the art may be enabled to make and use the invention. These details and descriptions are representative only of certain preferred embodiments, however, a myriad of other embodiments which will not be expressly described will be readily understood by one having skill in the art upon a thorough review of the instant disclosure. Accordingly, any reviewer of the instant disclosure should interpret the scope of the invention only by the claims, as such scope is not intended to be limited by the embodiments described and illustrated herein.

For purposes herein, reference numbers are provided in the drawings for illustrating certain features of embodiments. Where distinct figures of the drawings utilize a shared reference number, it can be appreciated that the feature corresponding to the shared reference number is the same or similar, perhaps observed from a different view, or observed with respect to a different embodiment deploying the same or similar feature.

For purposes herein, the term “coupled” means that the coupled components, articles, or systems are separable from each other.

The term “attached” means that the attached components, articles, or systems are not separable from each other.

The term “integrated” means that the integrated components, articles, or systems refer to features which together form a continuous body.

The term “joined” may be taken to mean “coupled,” “attached,” “integrated,” or some combination thereof.

Unless explicitly defined herein, terms are to be construed in accordance with the plain and ordinary meaning as would be appreciated by one having skill in the art.

### GENERAL DESCRIPTION OF EMBODIMENTS

In some embodiments, the nozzle is comprised of two primary components, the neck and the collar. In such embodiments, the collar may be comprised of a first end and a second end. The neck may comprise a back end and a front end. The first end of the collar may be adapted with threads such that it may be coupled a hose fitting or another type hydraulic conduit. The collar creates a substantially water-tight seal with the hose fitting. In preferred embodiments, the second end of the collar may couple with the back end of the neck. The collar creates a substantially water-tight seal with the back end of the neck.

In some embodiments, the neck component is monolithic, meaning that it is formed by a continuous piece of material. In such embodiments, there may be no moving parts in the neck. In some embodiments, the collar component is monolithic, meaning that it is formed by a continuous piece of material. In such embodiments, there may be no moving parts in the neck.

In some embodiments, the nozzle is comprised of a single continuous body which combines the neck and the collar. Similar to embodiments having a separate neck and collar, the continuous body embodiment has an entry aperture disposed on the back end, an exit aperture disposed on the front end, and a waterway which passes through the nozzle between the entry aperture and the exit aperture. In some embodiments the area enclosed by the entry aperture of the continuous body nozzle equals the area enclosed by the exit aperture. In some embodiments, a cross-sectional area of the waterway at any point between the entry aperture and the exit aperture equals the area of the entry aperture and the area of the exit aperture.

The neck has at least one aperture towards its back end called the entry aperture. The neck has at least one aperture towards the front of the nozzle called the exit aperture. The pathway for water to flow between the entry aperture and the exit aperture is called the waterway. In some embodiments, the area of the entry aperture may equal the area enclosed by the exit aperture.

The axis between the entry aperture and exit aperture is referred to as the waterway axis. In some embodiments, the cross-sectional area of the waterway remains constant between the entry aperture and the exit aperture along the waterway axis. This specialized “constant-area” waterway may improve the fluid dynamics of the nozzle. In particular, a waterway having a constant cross-sectional area throughout the length of the waterway may help reduce turbulence and encourage laminar flow. The laminar flow through the waterway creates a substantially laminar spray pattern exiting the exit aperture. A laminar spray pattern can increase reach and penetration of the stream of water exiting the nozzle.

In some embodiments, the nozzle has rounded corners where two surface come together. These rounded corners are called beveled edges, and they may be disposed on inside corners and/or on outside corners, depending on the embodiment. Beveled edges aid in reducing potential fluid turbulence through the nozzle. In some embodiment, beveled edges are located within the waterway where two sides of the waterway meet. In some embodiments, beveled edges are located on the neck immediately upstream of the entry aperture, where the neck and collar come together. In other embodiments, the entry aperture itself may have beveled edges. In some embodiments, the beveled edge may be a rounded bevel, a tapered bevel, or some combination thereof.

A variety of exit aperture geometries are conceivable. The rectangular exit aperture with beveled edges is preferred for some firefighting applications. However, other exit apertures are possible. Some exit apertures may form a much more elongated rectangle to produce a fan spray pattern. Some exit apertures may form a rectangle with a circle in the center to produce a blade spray pattern with special flow concentration in the center. It's conceivable that in some embodiments an exit aperture could form a triangle, pentagon, or hexagon. In embodiments having irregular exit apertures the area of the nozzle entry aperture, the area of the nozzle exit aperture, and the cross-sectional area of the waterway at any point between the entry aperture and the exit aperture are equal.

In some embodiments, the entry aperture of the nozzle may be circularly shaped. In some embodiments with circularly shaped entry apertures, the entry aperture may have a diameter dimension of between 18 mm-27 mm. In some embodiments the entry aperture may have a diameter dimension of 22.23 mm (⅞ inches). In some embodiments the entry aperture may have a diameter dimension of 23.81 mm ( 15/16 inches).

In some embodiments, the exit aperture of the nozzle may be rectangularly shaped. In some embodiments, the exit aperture may have a width dimension of between 8 mm-16 mm. In some embodiments, the exit aperture may have a length dimension of between 28 mm-42 mm. These dimensional ranges have been selected due to their favorability in firefighting applications of the nozzle. Other applications of the nozzle may have length and or width dimensions which fall outside these firefighting-derived preferred ranges.

In some embodiments, the waterway length between the entry aperture and the exit aperture may be between 28 mm-42 mm.

The angles of the inside surfaces of the waterway produce a spray angle. The water spray angle along the exit aperture length may be of particular importance because it affects the spread of the spray pattern. In some embodiments, the spray angle along the exit aperture length dimension may be between 5 degrees to 9 degrees. For example and without limitation, the spray angle along the exit aperture length dimension may be 7 degrees. Similarly, the spray angle along the exit aperture width dimension assists in shaping the spray pattern. In some embodiments, the spray angle along the exit aperture width dimension may be between 5 degrees to 9 degrees. For example and without limitation, the spray angle along the exit aperture width dimension may be 7 degrees. Note that the spray angle along the exit aperture length dimension is a widening angle and the spray angle along the exit aperture width dimension is a tapering angle.

These spray angle ranges and discrete spray angle values have been empirically determined to produce the most useful spray pattern for certain firefighting situations, including but not limited to spraying water through a window or doorway from a relatively safe distance. If the spray angle along the length dimension is below the preferred range the spray angle lacks adequate dispersion, reducing the nozzle's fire extinguishing capability. If the spray angle along the width dimension is above the preferred range, the spray angle may cause some of the peripheral water to impact the side of the structure outside the window or doorway, thereby reducing the nozzle's fire extinguishing capability.

### Materials

The nozzle can be made out of a variety of materials. In some embodiments, the nozzle may be made from aluminum, bronze, stainless steel, or plastic. For example and without limitation, the collar and/or the neck may be formed from plastics such as polycarbonate, polyvinyl chloride (PVC), polypropylene (PP), polyvinylidene fluoride (PVDF). In some embodiments, the neck and collar may be formed from dissimilar materials.

In some embodiments, the coupling between the collar and the neck may be adapted with an o-ring such that the water-tightness between the collar and neck is improved.

In some embodiments, the neck may be configured with a spray pattern indicator. The spray pattern indicator indicates the orientation of the exit aperture to the user. The spray pattern indicator forms a shape having a wider section towards the front end of the nozzle. For example and without limitation, the wide section of the spray pattern indicator may be aligned with a wide section of the exit aperture. In some embodiments, the spray pattern indicator may be a triangular, conical, or trapezoidal shape. In some embodiments, the spray pattern indicator may be an indentation into the outside surface of the neck. In some embodiments, the spray pattern indicator may be raised above the outside surface of the neck.

While various details, features, and combinations are described in the illustrated embodiments, one having skill in the art will appreciate a myriad of possible alternative combinations and arrangements of the features disclosed herein. As such, the descriptions are intended to be enabling only, and non-limiting. Instead, the spirit and scope of the invention is set forth in the appended claims.

In some embodiments, the circumference of the neck is flared towards the front end. This flared section may have grip to improve the user's ability to handle and manipulate the nozzle. In some embodiments, the flared section may form a continuous symmetrical ring around the circumference. In some embodiments, the flared section may not be symmetrical. In some embodiments, there may be two flat sections on opposite sides of the nozzle. The flat sections may be positioned such that they align the exit aperture length. This configuration can assist the user in quickly recognizing the orientation of the exit aperture by looking at the flat sections.

### First Illustrated Embodiment

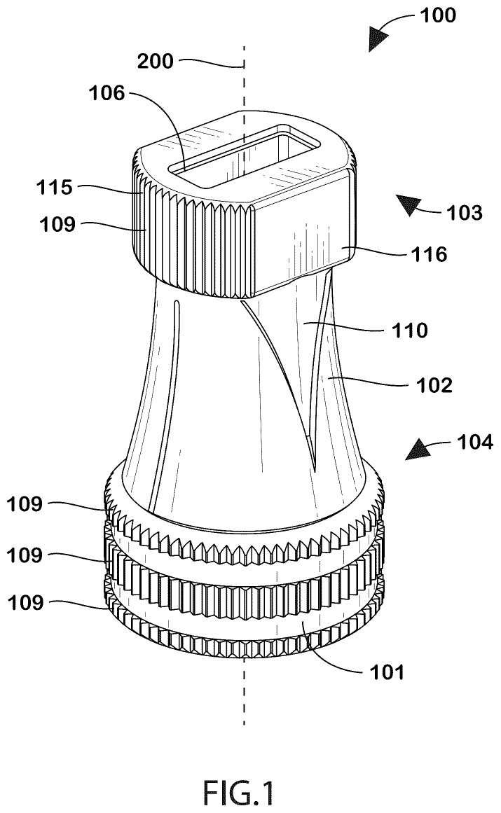

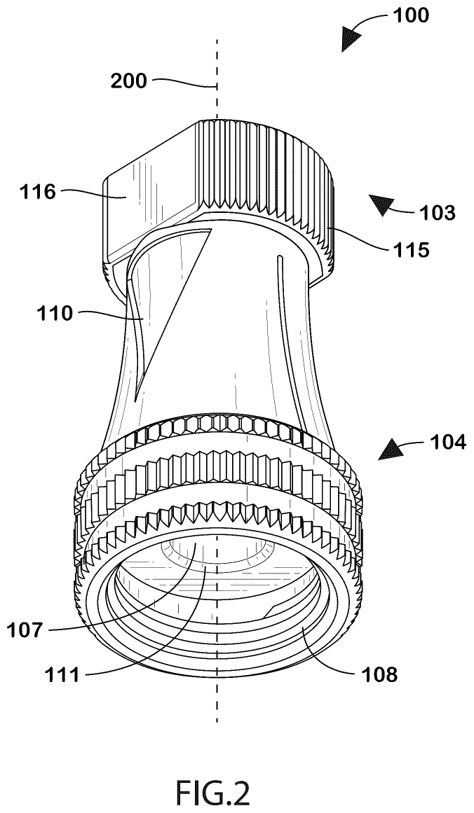

Now turning to the drawings, FIG. 1 and FIG. 2 show a first embodiment of the nozzle (100). The first embodiment comprises a collar (101) and a neck (102). The back end (104) of the neck is coupled to the collar in the first embodiment, but in other embodiments the neck and collar may be attached together permanently or integrated together, forming a continuous piece of material. The nozzle has grip (109) towards the front end (103) of the neck and additional grip around the collar. In FIG. 2 The nozzle threads (108) are depicted. In the first embodiment the nozzle threads enable the nozzle to be coupled to a hose or other types hydraulic conduits. FIG. 1 and FIG. 2 also depict the flared section (115) towards the front end of the neck. In this embodiment, there are two flat sections (116) on the flared section which are aligned with the exit aperture length (203) dimension.

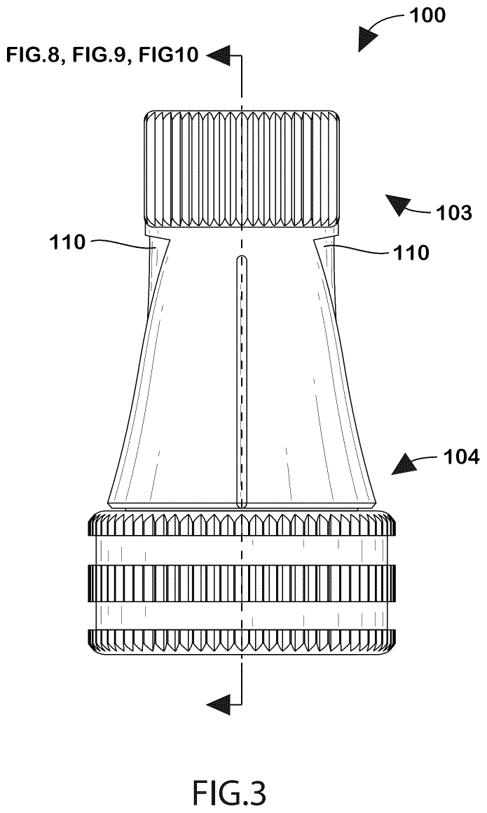

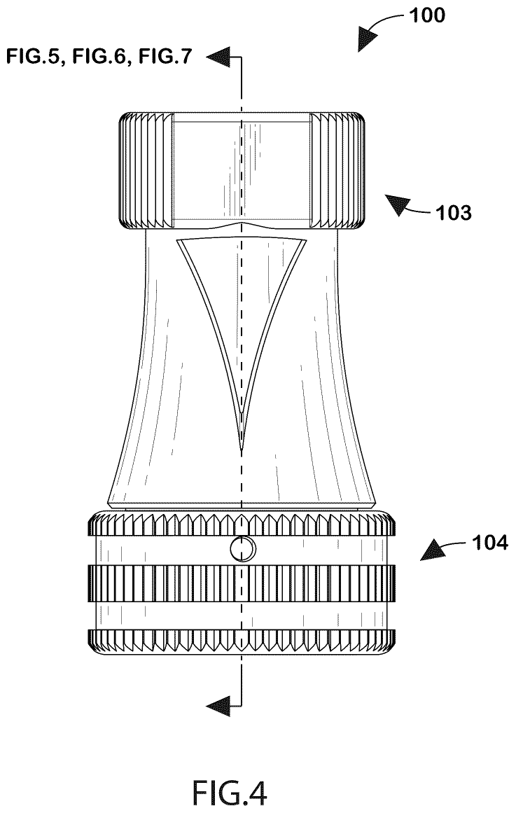

FIG. 3 shows a side profile of the nozzle (100), and FIG. 4 shows a top plan view of the nozzle. FIG. 3 depicts both the spray pattern indicators (110) disposed on the neck. A spray pattern indicator can also be seen in FIG. 1 and FIG. 2.

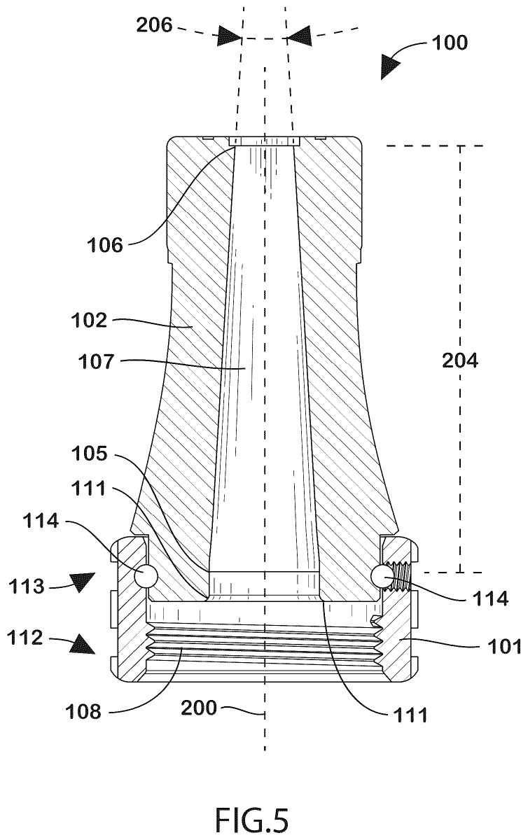

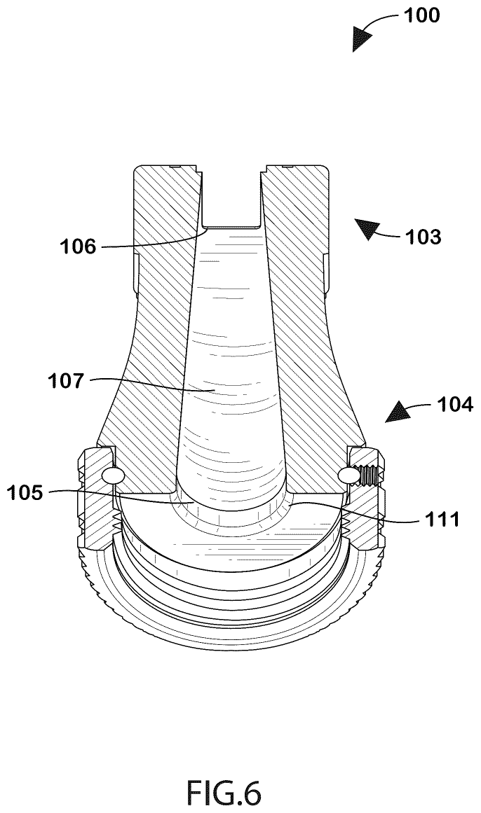

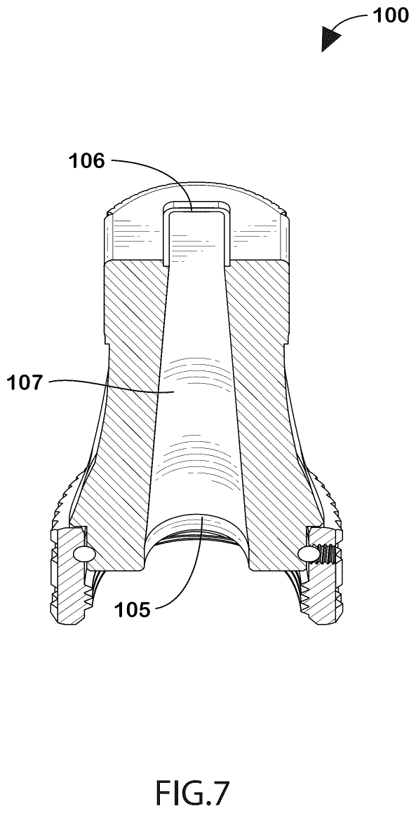

FIG. 5-FIG. 7 show side sectional views of the first embodiment of the nozzle (100). In these figures the waterway (107) between the entry aperture (105) and the exit aperture (106) is depicted. The entry aperture is where liquid enters the waterway near the back end (104) of the neck. The exit aperture is where the liquid exits the waterway near the front end (103) of the neck. The waterway axis (200) is an imaginary line that centered within the waterway. The waterway length (204) distance is also identified in FIG. 5.

FIG. 5 shows the collar (101) as having a first end (112) and a second end (113). The first end is configured with nozzle threads (108) such that the nozzle may be coupled with a hose, and the second end is configured with an o-ring (114) and other features such that the collar may be coupled to the neck (102). The o-ring between the neck and collar also improves the watertightness of the coupling between the collar and the neck. FIG. 5 shows the width dimension spray angle (206) formed by the inside surfaces of the waterway. The angle of the surfaces along the exit aperture width (202) dimension create the spray angle depicted.

It is important to notice that the entry aperture (105) and the exit aperture (106) take the form of different geometrical shapes. In this first embodiment the entry aperture is a circle, and the exit aperture is a rectangular shape with rounded corners. The area of the entry aperture, the area of the exit aperture, and the cross-sectional area of the waterway (107) at any point along the waterway axis, are equal. The waterway smoothly transitions from the entry aperture to the exit aperture while maintaining a constant cross-sectional area.

The nozzle (100) exhibits rounded corners in multiple locations. These rounded corners are called beveled edges (105), and they may be disposed on inside corners and/or outside corners, depending on the embodiment. In the first embodiment, beveled edges are disposed within the waterway (107) where two sides of the waterway meet. In the first embodiment, beveled edges are disposed on the neck (102) immediately upstream of the entry aperture (105), where the neck and collar (101) come together.

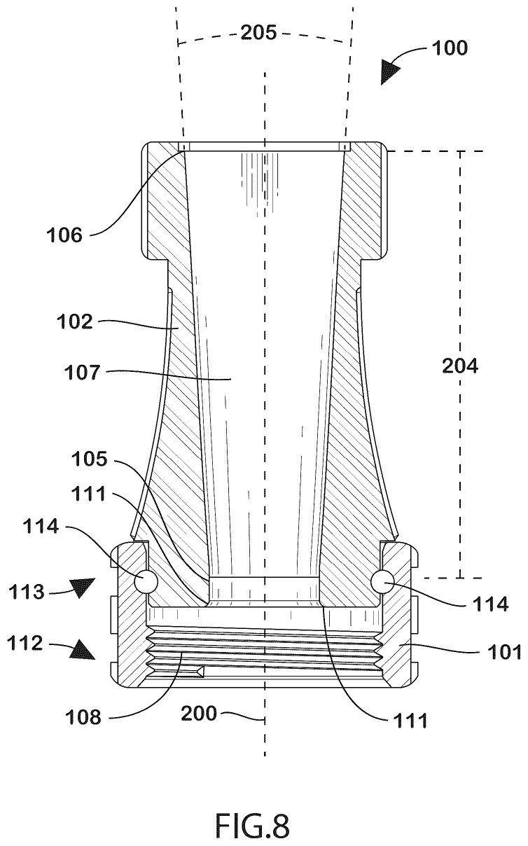

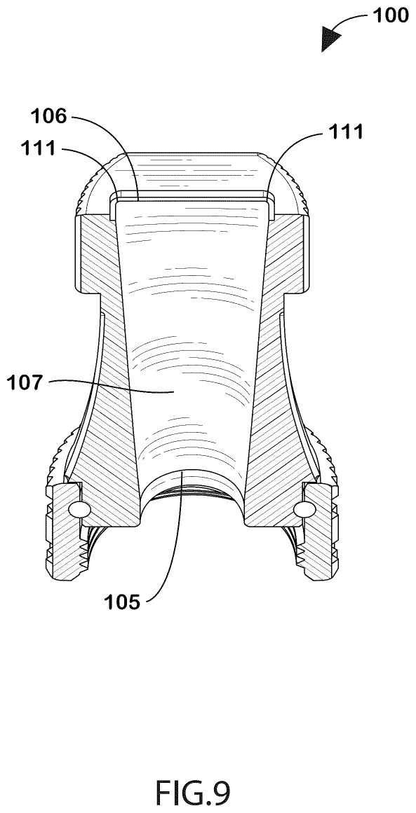

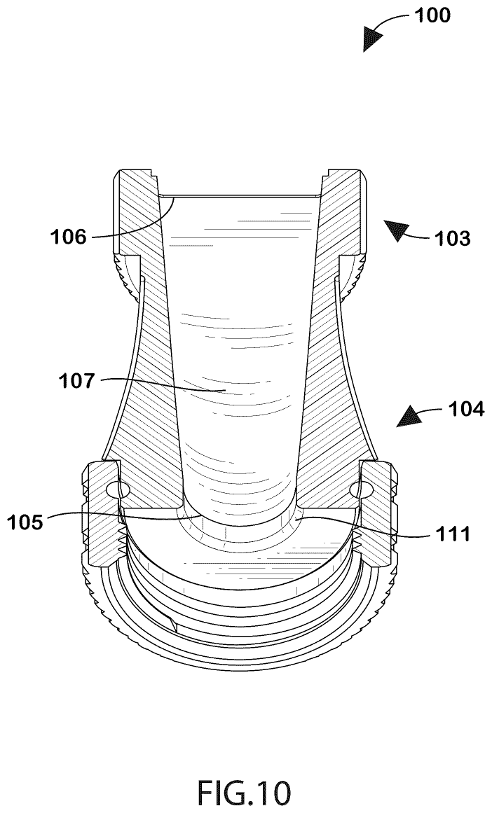

FIG. 8-FIG. 10 show sectional plan views of the first embodiment of the nozzle (100). These figures identify many of the same features depicted in FIG. 5-FIG. 8 but from a plan view angle. FIG. 8 shows the length dimension spray angle (205) formed by the inside surfaces of the waterway. The angle of the surfaces along the exit aperture length (203) dimension create the spray angle depicted.

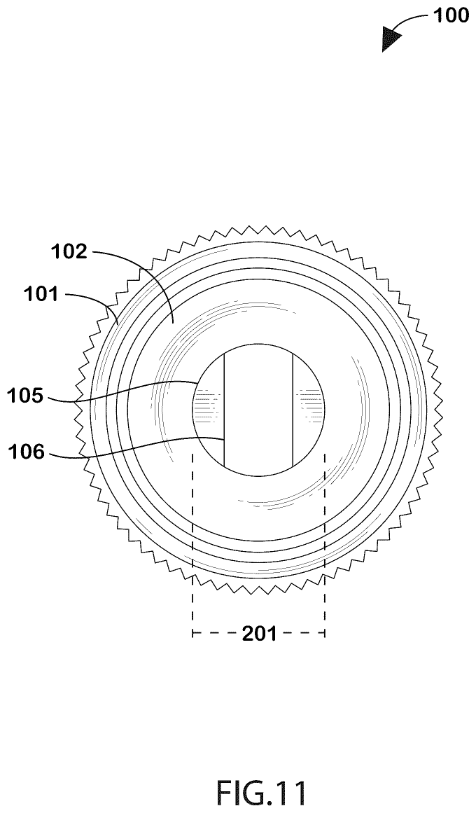

FIG. 11 shows the nozzle from its back end. The exit aperture (106) may be seen through the entry aperture (105). The collar (101) is shown around the back end (104) of the neck (102). The entry aperture is shown as a circular shape having an entry aperture diameter (201) dimension identified.

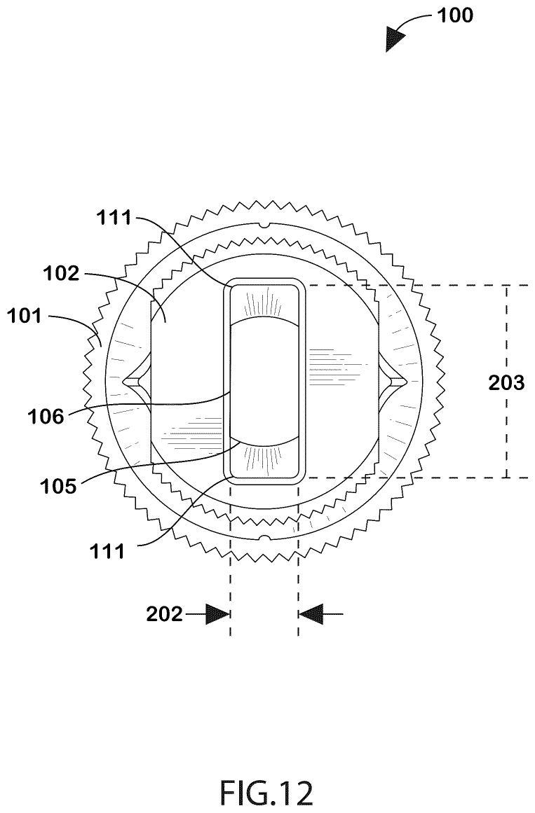

FIG. 12 shows the nozzle from its front end. The entry aperture (105) may be seen through the exit aperture (106). The collar (101) is shown around the back end (104) of the neck (102). The exit aperture is shown as a rectangular shape having beveled edges. An exit aperture width (202) dimension and an exit aperture length (203) dimension are identified.

### Second Illustrated Embodiment

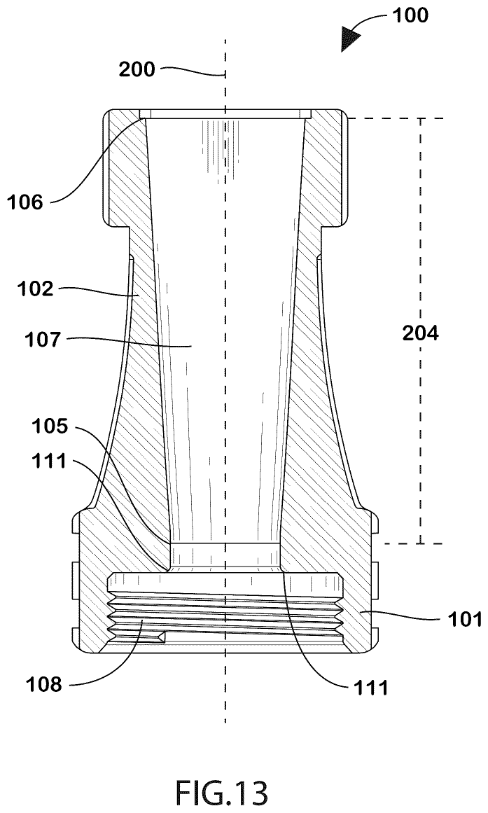

FIG. 13 show a second embodiment of the nozzle (100). In the second embodiment the collar (101) and neck (102) are integrated with each other forming a continuous. Similar to the first embodiment, the area of the entry aperture (105), the area of the exit aperture (106), and the cross-sectional area of the waterway (107) at any point along the waterway axis (200), are equal.

### Third Illustrated Embodiment

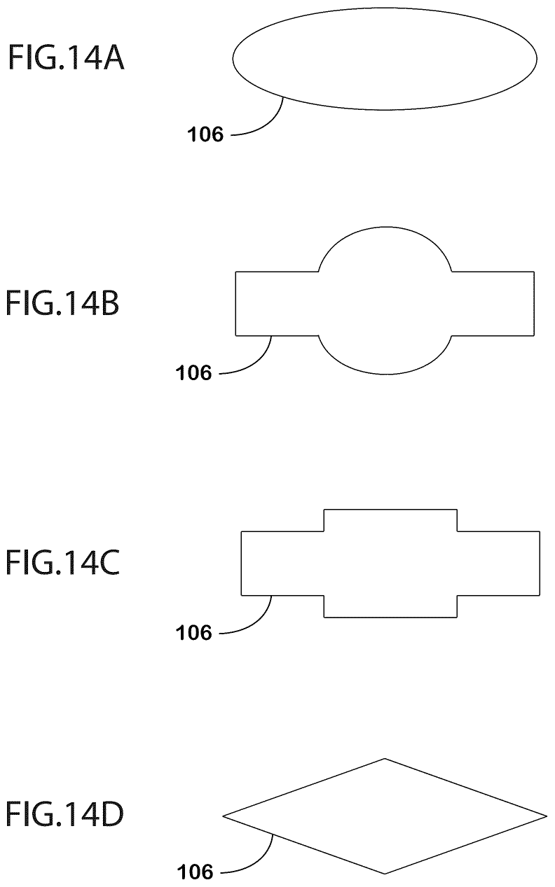

FIG. 14A shows an exit aperture (106) shape for a third illustrated embodiment.

### Fourth Illustrated Embodiment

FIG. 14B shows an exit aperture (106) shape for a fourth illustrated embodiment.

### Fifth Illustrated Embodiment

FIG. 14C shows an exit aperture (106) shape for a fifth illustrated embodiment.

### Sixth Illustrated Embodiment

FIG. 14D shows an exit aperture (106) shape for a sixth illustrated embodiment.

In embodiments utilizing exit aperture shapes depicted in FIG. 14A-FIG. 14D, the area of the entry aperture (105), the area of the exit aperture, and the cross-sectional area of the waterway (107) at any point along the waterway axis (200), are equal.

Feature List

| | |
|---|---|
| Nozzle | (100) |
| Collar | (101) |
| Neck | (102) |
| Front End | (103) |
| Back End | (104) |
| Entry Aperture | (105) |
| Exit Aperture | (106) |
| Waterway | (107) |
| Nozzle Threads | (108) |
| Grip | (109) |
| Spray Pattern Indicator | (110) |
| Beveled Edge | (111) |
| First End | (112) |
| Second End | (113) |
| O-Ring | (114) |
| Flared Section | (115) |
| Flat Section | (116) |
| Waterway Axis | (200) |
| Entry Aperture Diameter | (201) |
| Exit Aperture Width | (202) |
| Exit Aperture Length | (203) |
| Waterway Length | (204) |
| Length Dimension Spray Angle | (205) |
| Width Dimension Spray Angle | (206) |

What is claimed is:

1. A liquid nozzle with a specialized waterway, comprising:
a. A neck; the neck having a front end and a back end, an entry aperture is disposed on the back end, and an exit aperture is disposed on the front end, a waterway passing through the neck between the entry aperture and the exit aperture, the area of the entry aperture equaling the area of the exit aperture;
b. A collar; the collar having a first end and a second end, the first end adapted with threads to couple with a threaded fitting, the second end configured to couple with, and create a substantially water-tight seal with, the back end of the neck.

2. The liquid nozzle with a specialized waterway of claim 1, wherein:
a. The cross-sectional area of the waterway along a waterway axis remains constant between the entry aperture and the exit aperture.

3. The liquid nozzle with a specialized waterway of claim 2, wherein:
a. The entry aperture is circularly shaped.

4. The liquid nozzle with a specialized waterway of claim 3, wherein:
a. The entry aperture has a diameter dimension of between 18 mm-27 mm.

5. The liquid nozzle with a specialized waterway of claim 3, wherein:
a. The entry aperture has a diameter dimension is 15/16 inches (approximately 23.81 mm).

6. The liquid nozzle with a specialized waterway of claim 3, wherein:
a. The entry aperture has a diameter dimension is ⅞ inches (approximately 22.23 mm).

7. The liquid nozzle with a specialized waterway of claim 2, wherein:
a. The exit aperture is rectangularly shaped.

8. The liquid nozzle with a specialized waterway of claim 7, wherein:
a. The exit aperture is rectangularly shaped with beveled edges.

9. The liquid nozzle with a specialized waterway of claim 7, wherein:
a. The exit aperture has a width dimension of between 8 mm-16 mm and a length dimension of 28 mm-42 mm.

10. The liquid nozzle with a specialized waterway of claim 2, wherein:
a. The waterway has a waterway length between 70 mm-120 mm.

11. The liquid nozzle with a specialized waterway of claim 10, wherein:
a. The waterway has a waterway length of 90 mm.

12. The liquid nozzle with a specialized waterway of claim 7, further comprising:
a. A spray pattern indicator is disposed on the outside surface of the nozzle, the spray pattern indicator having a wider section, the wider section of the spray pattern indicator aligning with the exit aperture length dimension.

13. The liquid nozzle with a specialized waterway of claim 12, further comprising:
a. A second spray pattern indicator is disposed on the outside surface of the nozzle, the second spray pattern indicator having a wider section, the wider section of the spray pattern indicator aligning with the exit aperture length dimension.

14. The liquid nozzle with a specialized waterway of claim 2, wherein:
a. The collar is made of a material selected from the group consisting of aluminum, stainless steel, brass, and plastic.

15. The liquid nozzle with a specialized waterway of claim 2, wherein:
a. The neck is made of a material selected from the group consisting of aluminum, stainless steel, brass, and plastic.

16. The liquid nozzle with a specialized waterway of claim 2, wherein:
a. The nozzle is adapted with a flared section toward the front end of the neck, the flared section having two flat sections on opposite sides of the neck which are aligned with the exit aperture length dimension.

17. The liquid nozzle with a specialized waterway of claim 2, wherein:
a. The angles of the inside surfaces of the waterway produce a spray angle along the exit aperture length dimension, the spray angle being between 5 degrees to 9 degrees.

18. The liquid nozzle with a specialized waterway of claim 2, wherein:
a. The angles of the inside surfaces of the waterway produce a spray angle along the exit aperture width dimension, the width dimension spray angle being between 5 degrees to 9 degrees.
A liquid nozzle with a specialized waterway, comprising:

19. A nozzle; nozzle having a front end and a back end, an entry aperture being disposed on back end, and an exit aperture being disposed on the front end, a waterway passing through the nozzle between the entry aperture and the exit aperture, the area of the entry aperture equaling the area of the exit aperture, the nozzle being adapted with threads near the back end to couple with a threaded fitting.

20. The liquid nozzle with a specialized waterway of claim 19, wherein:
a. The cross-sectional area of the waterway along a waterway axis remains constant between the entry aperture and the exit aperture.
